(19) United States
(12) Patent Application Publication
(10) Pub. No.: US 2008/0160868 A1
(43) Pub. Date: Jul. 3, 2008

(54) METHOD OF MANUFACTURING BARRIER RIBS FOR PLASMA DISPLAY PANEL AND METHOD OF MANUFACTURING LOWER PANEL HAVING THE BARRIER RIBS

(75) Inventors: DONG-YOL YANG, Daejeon (KR); SEUNG-MIN RYU, Daejeon (KR); SUK-HEE PARK, Daejeon (KR); JONG-SEO CHOI, Suwon-si (KR); KWI-SEOK CHOI, Suwon-si (KR); BEOM-WOOK LEE, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/964,258

(22) Filed: Dec. 26, 2007

(30) Foreign Application Priority Data
Dec. 29, 2006 (KR) 2006-138902
May 31, 2007 (KR) 2007-53418

(51) Int. Cl. H01J 9/00

(52) U.S. Cl. 445/24

(57) ABSTRACT

A method of manufacturing barrier ribs of a plasma display panel (PDP), and a method of manufacturing a lower panel for the PDP. The method of manufacturing the barrier ribs for the PDP includes: preparing a mold to shape the barrier ribs, which has a patterned surface; filling a plurality of channels formed in the mold with a barrier rib material, to form barrier ribs; and compression bonding a dielectric sheet to the barrier ribs in the mold. Using a molding process, a barrier rib pattern having a desired shape can be precisely formed, and an electrode burying layer with a uniform thickness can be obtained.

### CROSS-REFERENCE TO RELATED APPLICATIONS

This application claims the benefit of Korean Applications Nos. 2006-138902, filed on Dec. 29, 2006, and 2007-53418, filed on May 31, 2007, in the Korean Intellectual Property Office, the disclosures of which is incorporated herein by reference.

### BACKGROUND OF THE INVENTION

1. Field of the Invention

Aspects of the present invention relate to a method of manufacturing barrier ribs included in a plasma display panel (PDP), and a method of manufacturing a lower panel including the barrier ribs.

2. Description of the Related Art

A plasma display panel (PDP) is a flat panel display (FPD), in which sustain electrodes and address electrodes are arranged in a matrix, between an upper substrate and a lower substrate. A plasma discharge is produced between the electrodes. The discharge creates ultraviolet (UV) rays, which excite phosphor layers, thereby forming a predetermined image.

FIG. 1 is an exploded perspective view of a conventional alternating current (AC) surface-discharge-type PDP. Referring to FIG. 1, the conventional AC surface-discharge-type PDP is manufactured by forming an upper panel 10 and a lower panel 20, using separate processes, and combining the upper and lower panels 10 and 20 opposite each other.

In the upper panel 10, an upper dielectric layer 12 and a protection layer 15 are sequentially formed on an upper substrate 11, on which pairs of sustain electrodes 16 are disposed. The upper dielectric layer 12 accumulates wall charges during a plasma discharge. The protection layer 15 protects the pairs of sustain electrodes 16 and the upper dielectric layer 12 from gas ion sputtering, and improves the emission of secondary electrons, during the plasma discharge.

In the lower panel 20, a lower dielectric layer 23 is formed on a lower substrate 21, on which a plurality of address electrodes 22 are formed, to bury the address electrodes 22. A plurality of barrier ribs 24 are disposed on the lower dielectric layer 23. The barrier ribs 24 partition a plurality of discharge spaces G, which form independent emission regions. Phosphor layers 25, for example, red (R), green (G), and blue (B) phosphor layers, are coated in the discharge spaces G. The phosphor layers 25 are excited by UV rays, which are emitted during the plasma discharge, to generate visible (V) rays, thereby forming a predetermined image. A mixture of inert gases, such as, He, Xe, and Ne, is injected and sealed in the discharge spaces G, at a pressure of 400 to 600 Torr.

Referring to FIG. 1, the barrier ribs 24 may be formed as open stripe-type barrier ribs, or as closed-type barrier ribs. When the barrier ribs 24 are the closed-type barrier ribs, a discharge efficiency is higher than when the barrier ribs 24 are the open stripe-type barrier ribs. The barrier ribs 24 maintain a predetermined distance between the upper and lower substrates 11 and 21, and partition the discharge spaces G. The barrier ribs 24 prevent the occurrence of electrical and optical cross-talk between the respective discharge spaces G, thereby improving image quality and color purity. Also, the barrier ribs 24 provide an area on which the phosphor layers 25 are coated, to thereby provide the luminance of the PDP. In addition, the barrier ribs 24 partition the discharge spaces G, to define unit pixels formed by R, G, and B discharge spaces G, and define a cell pitch between the discharge spaces G, to determine the resolution of an image.

Accordingly, the barrier ribs 24 are an essential component for improving image quality and luminous efficiency. Thus, a variety of research has been conducted on barrier rib technology, due to the recent demand for large-area, high-resolution panels. Conventionally, barrier ribs are manufactured using a screen printing method, a sandblasting method, an etching method, or a photolithographic method using photosensitive paste. However, it is difficult to form high-resolution barrier ribs using the above-described methods, and the productivity of the methods is low.

### SUMMARY OF THE INVENTION

Aspects of the present invention provide a method of manufacturing barrier ribs for a plasma display panel (PDP), in which a desired barrier rib pattern can be accurately formed. Aspects of the present invention provide a method of manufacturing a lower panel that includes the barrier ribs.

Aspects of the present invention provide a method of manufacturing a lower panel of a PDP, in which an electrode burying layer with a uniform thickness can be formed.

Aspects of the present invention provide a method of manufacturing a lower panel of a PDP, which can be easily performed and automated.

According to an aspect of the present invention, there is provided a method of manufacturing barrier ribs of a PDP. The method includes: preparing a mold to shape the barrier ribs, which has a patterned surface; filling a plurality of channels formed in the mold with a barrier rib material, to form the barrier ribs; disposing a dielectric sheet opposite the mold; and compressing the dielectric sheet against the mold, to bond the dielectric sheet to the barrier ribs.

According to another aspect of the present invention, there is provided a method of manufacturing a lower panel of a PDP. The method includes: preparing a mold to shape barrier ribs, which has a patterned surface; filling a plurality of channels formed in the mold with a barrier rib material, to form barrier ribs; disposing a dielectric sheet opposite the mold; compressing the dielectric sheet against the mold, to bond the dielectric sheet to the barrier ribs; and compressing the dielectric sheet against a substrate having exposed electrodes, to bond the dielectric sheet to the substrate, and thereby form the lower panel.

According to yet another aspect of the present invention, there is provided a method of manufacturing a lower panel of a PDP, using a manufacturing apparatus. The manufacturing apparatus includes: a filling table disposed on a first side of the manufacturing apparatus, a compression table disposed on a second side of the manufacturing apparatus, and a mold rotation driver that attaches to a mold, to transfer the mold between the filling table and the compression table. The method includes: providing the mold, which has a patterned surface; disposing the mold on the filling table, and mounting the mold on the mold rotation driver; filling channels of the mold with a barrier rib material, to form barrier ribs; compressing a dielectric against the mold, to compression bonding the dielectric sheet to the barrier ribs; disposing a substrate having a plurality of electrodes on the compression table; driving the mold rotation driver, to transfer the mold, to which the dielectric sheet is bonded, onto the substrate; and compression bonding the dielectric sheet to the substrate and the electrodes.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the exemplary embodiments, taken in conjunction with the accompanying drawings, of which;

FIG. 1 is an exploded perspective view of a conventional alternating current (AC) surface-discharge-type plasma display panel (PDP);

FIG. 2 is a process flowchart illustrating a method of manufacturing a lower panel of a PDP, according to an exemplary embodiment of the present invention;

FIGS. 3A through 3J are cross-sectional views illustrating the method of FIG. 2, according to an exemplary embodiment of the present invention;

FIG. 4 is a perspective view of a soft mold used to manufacture barrier ribs, according to an exemplary embodiment of the present invention;

FIG. 5 is a perspective view taken along a line A-A′ of FIG. 4, according to an exemplary embodiment of the present invention;

FIG. 6 is a schematic diagram of an apparatus used to manufacture a lower panel, according to an exemplary embodiment of the present invention; and

FIGS. 7A through 7J are cross-sectional views illustrating a method of manufacturing a lower panel using the apparatus shown in FIG, 6, according to an exemplary embodiment of the present invention.

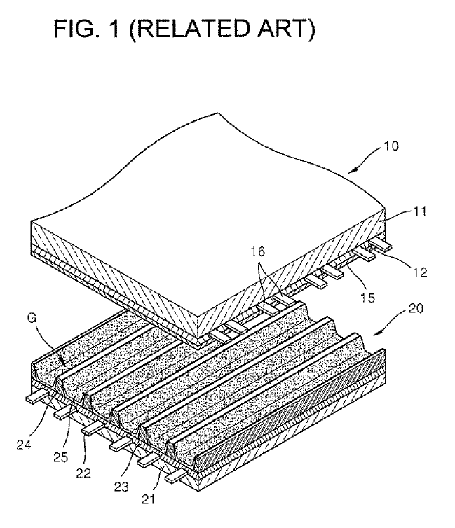

### DETAILED DESCRIPTION OF THE EMBODIMENTS

Reference will now be made in detail to the exemplary embodiments of the present invention, examples of which are illustrated in the accompanying drawings, wherein like reference numerals refer to the like elements throughout. The exemplary embodiments are described below, in order to explain the aspects of the present invention, by referring to the figures.

Hereinafter, a method of manufacturing barrier ribs of a plasma display panel (PDP) and a lower panel of a PDP, according to exemplary embodiments of the present invention, will be described. A process of manufacturing the barrier ribs of the PDP will be described along with a process of manufacturing the lower panel, since the two processes are performed consecutively.

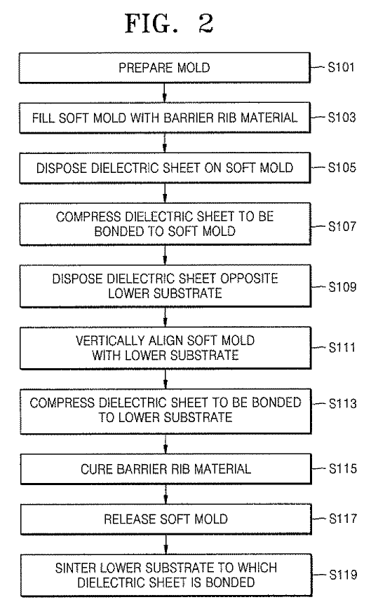

FIG. 2 is a process flowchart illustrating a method of manufacturing a lower panel of a PDP, according to an exemplary embodiment of the present invention. A soft mold to shape barrier ribs is prepared in operation S101. In operation S103, a barrier rib material is filled in the prepared soft mold, to form the barrier ribs. In operation S105, a dielectric sheet is disposed on the soft mold, in which the barrier ribs are disposed. In operation S107, pressure is applied to the dielectric sheet, so that the dielectric sheet is compressed and bonded to the soft mold. In operation S109 the dielectric sheet, which is bonded to the barrier ribs in soft mold, is disposed opposite a lower substrate of a PDP. In operation S111 the dielectric sheet is aligned with the lower substrate, in a vertical direction. In operation S113 the dielectric sheet is compressed against the lower substrate. The barrier ribs in the soft mold are cured in operation S115, and the soft mold is removed in operation S117. The resultant lower panel is sintered in operation S119, thereby completing the manufacture of the lower panel.

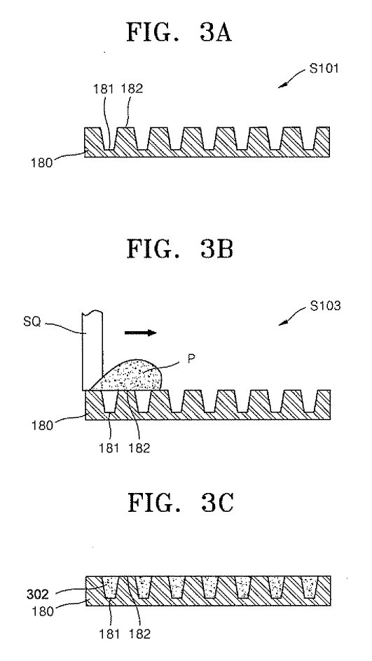

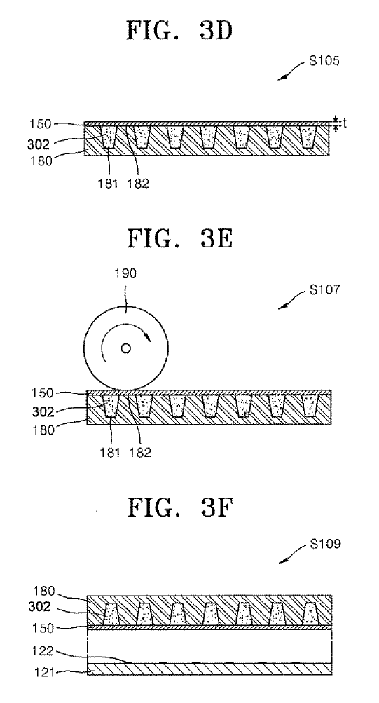

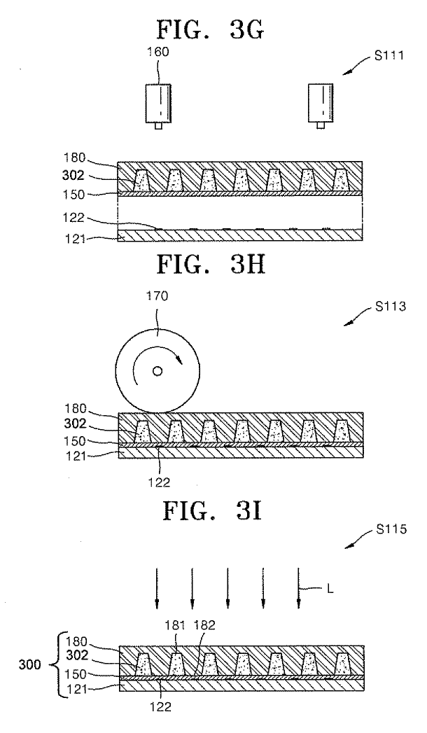

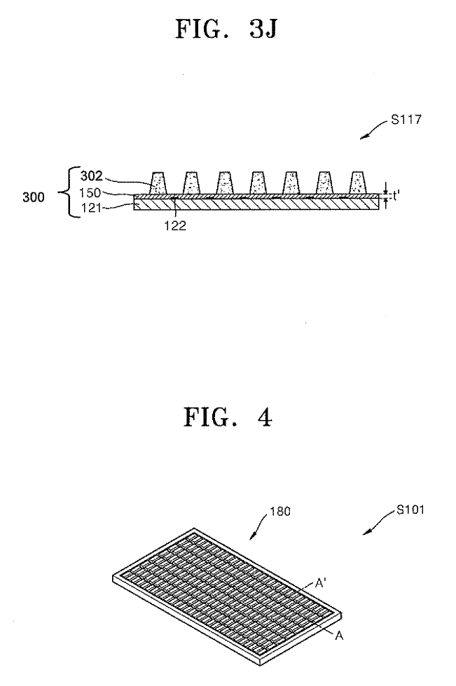

Hereinafter, operations S101 through S119 will be described in detail, with reference to FIGS. 3A through 3J. FIGS. 3A through 3J are cross-sectional views illustrating the method of FIG. 2, according to an exemplary embodiment of the present invention.

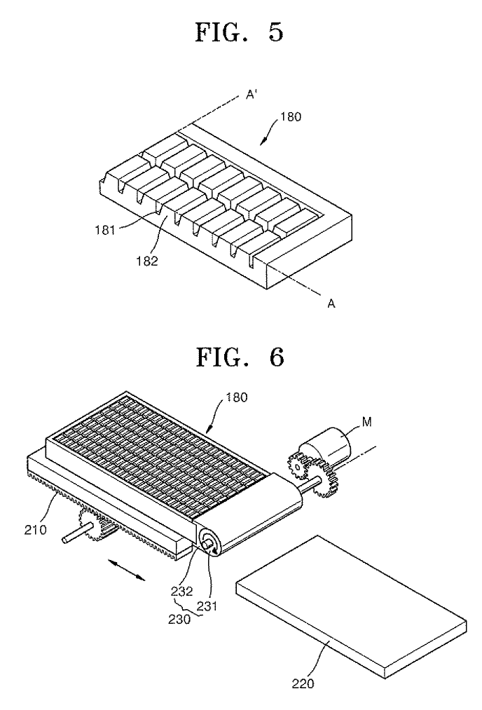

Referring to FIG. 3A, a soft mold 180 to shape barrier ribs is prepared. The soft mold 180 includes channels 181 and projections 182 formed alternately along the length of the soft mold 180. For reference, FIG. 4 illustrates a perspective view of the soft mold 180, and FIG. 5 illustrates a perspective view taken along a line A-A′ of FIG. 4, according to an exemplary embodiment of the present invention.

The soft mold 180 may be formed of a flexible material, such as, an engineering plastic or a silicon rubber. The soft mold 180 has lower surface energy, and better release characteristics, than a hard mold formed of a hard material, such as, a metal, a metal oxide, or a ceramic. The soft mold 180 absorbs vibrations and/or motions, which occur during a release process, and does not apply a load to the completed barrier rib pattern. Thus, a deformation of the barrier rib pattern can be structurally prevented. The soft mold 180 may be formed of a material having a high optical transparency, to allow a barrier rib material (barrier ribs), filled in the channels 181, to be radiated light (UV light).

Referring to FIG. 3B, a barrier rib material P is filled in the channels 181 of the soft mold 180. More specifically, a sufficient amount of barrier rib material P is deposited on the soft mold 180, and a pressure is applied to the barrier rib material P, by moving a squeegee SQ from one end of the soft mold 180 to another end thereof. The barrier rib material P is filled in each of the channels 181 of the soft mold 180, thereby forming barrier ribs 302. A photosensitive paste may be used as the barrier rib material P, but the present invention is not limited thereto. The use of the squeegee SQ facilitates the process of filling the barrier rib material P in the respective channels 181 in exact quantities, and to a uniform height. After the channels 181 are filled with the barrier rib material P, the soft mold 180 can have a nearly planar top surface, as illustrated in FIG. 3C. The barrier ribs 302 in the soft mold 180 can undergo, for example, a curing process while in the channels 181. As long as the channels 181 can be filled with a liquid or solid barrier rib material P, any known process of filling the channels 181 may be used. In this regard, the use of the squeegee SQ described above is only an example.

Referring to FIG. 3D, a dielectric sheet 150 is disposed on the soft mold 180. The dielectric sheet 150 is combined with the barrier ribs 302 contained in the channels 181, by the following process. The dielectric sheet 150 structurally connects the barrier ribs 302, and buries electrodes. For this reason, the dielectric sheet 150 may be formed to a sufficient thickness “t” to bury the electrodes, and to prevent the occurrence of an electrical breakdown. According to an exemplary embodiment of the present invention, the dielectric sheet 150, which has a predetermined thickness “t”, constitutes a dielectric material for burying electrodes. Thus, the thickness t of the dielectric material can be precisely and uniformly controlled.

Referring to FIG. 3E, the dielectric sheet 150 is compressed and bonded to barrier ribs 302 in the soft mold 180, using a pressure roller 190. In this case, the pressure roller 190 applies a predetermined pressure, and is moved on the dielectric sheet 150, from one end of the dielectric sheet 150 to another end thereof. The dielectric sheet 150 is attached to the soft mold 180, compressed, and shaped to a relatively small, uniform thickness, and can have a flattened top surface. By using the pressure roller 190, the dielectric sheet 150 can be closely adhered to the barrier ribs 302 filled in the soft mold 180. Furthermore, any excess barrier rib material P remaining on the projections 182 of the soft mold 180, may be removed by the pressure roller 190, and externally discharged.

After the above-described compression process is performed, the dielectric sheet 150, which is attached to the soft mold 180, is inverted over a lower substrate 121 of a PDP, as illustrated in FIG. 3F. More specifically, the lower substrate 121, such as, a glass substrate, or a plastic flexible substrate, is prepared. The lower substrate 121 includes a plurality of electrodes 122 disposed on a surface thereof, parallel to one another. Thereafter, the dielectric sheet 150 is disposed on the lower substrate 121 to cover the electrodes 122, such that the soft mold 180 is disposed above the lower substrate 121.

Referring to FIG. 3G, the soft mold 180 is vertically aligned with the electrodes 122 of the lower substrate 121. In order to perform the alignment process, alignment marks (not shown) may be formed in the soft mold 180 and the lower substrate 121. The alignment marks may be recognized by an optical detector, for example, a charge-coupled device (CCD) 160, to determine an alignment state between the soft mold 180 and the lower substrate 121. A misalignment can be corrected, based on image data produced by the CCD 160. The misalignment may be corrected by moving the soft mold 180 relative to the lower substrate 121. For example, since the electrodes 122 are disposed between the barrier ribs 302 (or adjacent to the barrier ribs 302), in order to perform exact addressing operations, the above-described alignment process is carried out during the manufacture of the lower panel.

Referring to FIG. 3H, the dielectric sheet 150 is compressed and bonded to the lower substrate 121, by applying pressure to a top (un-patterned) surface of the soft mold 180. More specifically, by applying a predetermined pressure to the top surface of the soft mold 180, using a pressure unit 170, the underlying dielectric sheet 150 is compressed and bonded (compression bonded) to the lower substrate 121, so that the electrodes 122 are buried by the dielectric sheet 150. The pressure unit 170 may be, for example, a pressure roller that applies a predetermined pressure to the top surface of the soft mold 180, and is rotated from one end of the soft mold 180 to another end thereof. The dielectric sheet 150 is a conventional dielectric layer that electrically insulates the electrodes 122 from each other, and protects the electrodes 122 from a discharge environment. Therefore, the dielectric sheet 150 is not separated from sides of the electrodes 122, and can completely bury the electrodes 122.

Referring to FIG. 3I, when the dielectric sheet 150 is sufficiently bonded to the lower substrate 121, a process of curing the barrier ribs 302 may be performed. The curing process may be performed when the barrier rib material P of the barrier ribs 320 is curable. The barrier ribs 302 are cured into a solid phase. The barrier rib material P has variable developing properties, according to the influence of heat, exposure, and other factors. For example, when photosensitive paste is used as the barrier rib material P, UV light L is radiated to the barrier rib material P (barrier ribs 302) filled in the channels 181 of the soft mold 180. The barrier rib material P, which is exposed to the UV light L, through the transparent soft mold 180, is cured to a solid phase, due to an internal photochemical reaction. During the UV-curing process, the barrier rib material P is integrally combined with the dielectric sheet 150. The portions of the barrier rib material P in each of the channels 181 constitute the barrier ribs 302. The barrier ribs 302 have a shape corresponding to the shape of the channels 181. The barrier ribs 302 are structurally connected to one another, by the dielectric sheet 150. The barrier ribs 302, the dielectric sheet 150 (which includes the electrodes 122), and the substrate 121 comprise a lower panel 300 of a PDP.

Referring to FIG. 3J, the soft mold 180 is released from the lower panel 300, and then removed. In the lower panel 300, the dielectric sheet 150 buries the electrodes 122, and the ribs 302 partition discharge spaces. Since the dielectric sheet 150 is formed of a sheet material with a constant thickness, the dielectric sheet 150 can have a uniform thickness, without an additional quality control (QC) process. The dielectric sheet 150 is compressed and bonded (compression bonded) to the lower substrate 121, as opposed to being coated by a conventional coating method. The dielectric sheet 150 can have a planar top surface, instead of a curved top surface, which often results from the conventional coating method, due to the shape of the electrodes 122. The number of processing operations can be reduced, as compared with a conventional method, in which a dielectric layer and barrier ribs are formed using separate operations.

According to another exemplary embodiment, the lower panel 300, from which the soft mold 180 is removed, may be sintered at an appropriate temperature, for example, at a temperature of about 500° C., or higher. As a result, the barrier ribs 302, which are bonded to the dielectric sheet 150, are cured, and the bonding of the dielectric sheet 180 to the lower substrate 121, can be reinforced. The sintering and UV curing processes can be used alone or in combination.

The dielectric sheet 150, which is attached to the barrier ribs 302, directly buries the electrodes 122 on the lower substrate 121. However, the present invention is not limited thereto, and an additional dielectric layer, to bury the electrodes 122, can be formed on the lower substrate 121. The additional dielectric layer may be interposed between the electrodes 122 disposed on the lower substrate 121, and the dielectric sheet 150.

Hereinafter, a method of manufacturing a lower panel 300 of a PDP, according to another exemplary embodiment of the present invention, will be described. The exemplary embodiment is generally similar to the previous exemplary embodiment, in terms of technical principles, but differs from the previous exemplary embodiment, in that a panel manufacturing apparatus is used to easily perform and automate the method. FIG. 6 is a schematic diagram of an apparatus used to manufacture a lower panel, according to an exemplary embodiment of the present invention.

Referring to FIG. 6, the apparatus includes: a movable filling table 210, which is disposed on one side of the apparatus, to provide a support surface during the filling of a barrier rib material P; and a fixed compression table 220, which is disposed on an opposing side of the apparatus, to provide a support surface during compression and bonding (compression bonding) of a dielectric sheet 150 to a substrate 121. A mold rotation driver 230 is interposed between the moving table 210 and the compression table 220. The rotation driver 230 fixes a soft mold 180 to one end thereof, and revolves, in order to transfer the soft mold 180 from the filling table 210 to the compression table 220. The mold rotation driver 230 includes a rotation axis, which is connected to a driving motor M. The rotation axis rotates clockwise or counterclockwise

The mold rotation driver 230 includes a mold combination member 232 (attachment member), which attaches the soft mold 180, and rotates along with the rotation axis 231. For example, the mold combination member 232 may be an elastically biased clip member, which can elastically fix the soft mold 180 therein. The mold combination member 232 may further include a screw (not shown), to fix an end portion of the soft mold 180, in order to reinforce the attachment of the mold combination member 232 and the soft mold 180. As an alternative to the screw, grooves (not shown) may be formed in top and bottom surfaces of the end portion of the soft mold 180, in one direction, and protrusions (not shown) having a shape conformable to the grooves may be formed on the mold combination member 232, so that the mold combination member 232 can slide to be combined with the soft mold 180.

The mold rotation driver 230 is intermittently rotated by a predetermined angle, in order to transfer the soft mold 180, to a position where a subsequent process will be performed. The filling table 210 may be capable of moving along a fixed path, such that it can be shunted from a moving path of the soft mold 180, which revolves in an arc. Due to the shunt operation of the filling table 210, the revolution of the mold rotation driver 230 departs from structural restrictions, and the degree of freedom of the mold rotation driver 230 is increased. In a variation of the current exemplary embodiment, the compression table 220 may be capable of moving instead of, or along with, the filling table 210.

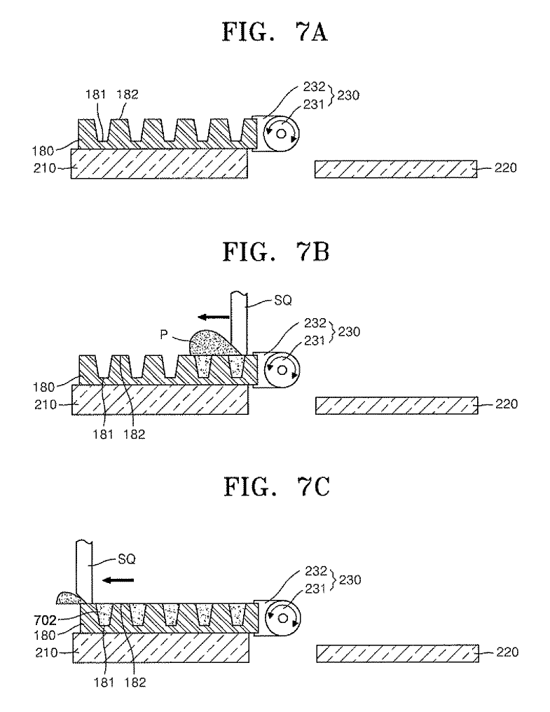

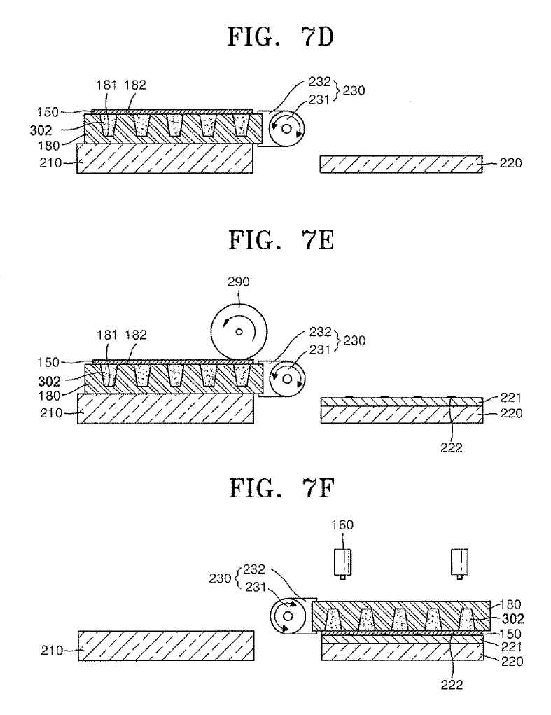

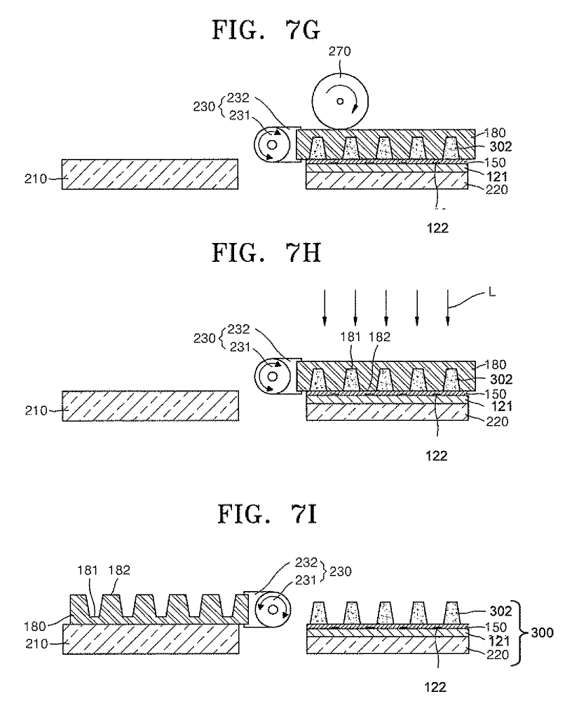

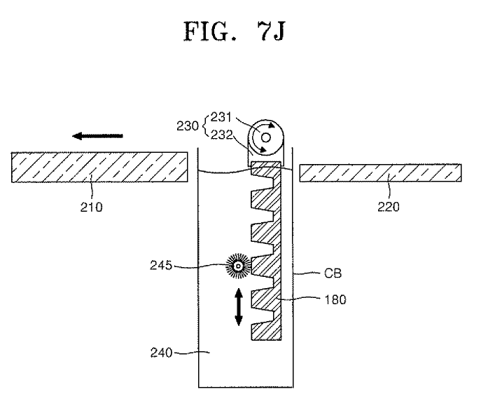

Hereinafter, a method of manufacturing a lower panel 300 for a PDP, according to an exemplary embodiment of the present invention, will be described with reference to FIGS. 7A through 7J. FIGS. 7A through 7J are cross-sectional views illustrating the method of manufacturing the lower panel 300, using the apparatus shown in FIG. 6.

Referring to FIG. 7A, a soft mold 180, having a mold pattern including regularly alternating channels 181 and projections 182, is prepared. Next, the prepared soft mold 180 is located on the moveable filling table 210, and an end portion of the soft mold 180 is attached by the mold rotation driver 230. For example, the end portion of the soft mold 180 may be forcibly inserted into, or slid into, the combination member 232 of the mold rotation driver 230. After the soft mold 180 is attached, the channels 181 of the soft mold 180 are filled with a barrier rib material P, as illustrated in FIGS. 7B and 7C. Specifically, the barrier rib material P is deposited on the soft mold 180, and moved by applying pressure, using a squeegee SQ, so that each of the channels 181 of the soft mold 180 can be filled with the barrier rib material P, thereby forming the barrier ribs 302.

Referring to FIG. 7D, a dielectric sheet 150 having a predetermined thickness is disposed on the soft mold 180. The dielectric sheet 150 constitutes a dielectric material to bury electrodes. Thus, the thickness of the dielectric material can be controlled precisely and uniformly.

Referring to FIG. 7E, the dielectric sheet 150 is compressed against the soft mold 180, and bonded (compression bonded) to barrier ribs 302, using a pressure roller 290. Specifically, the pressure roller 290 is pressed against the top surface of the dielectric sheet 150, and rotated from one end of the dielectric sheet 150 to another end thereof, so that the dielectric sheet 150 is compressed against the soft mold 180. Thus, the dielectric sheet 150 may be shaped to a uniform thickness, pressed against the projections 182, and be closely adhered to the barrier rib material P (barrier ribs 302) filled in the channels 181. While the dielectric sheet 150 is pressed against the projections 182, any excess barrier rib material P remaining on the projections 182 may be pushed out by the pressure roller 290 in one direction, and externally discharged.

After or during the above-described compression process, a lower substrate 121 of a PDP is disposed on the compression table 220, where subsequent processes will be performed. The lower substrate 121 may be a glass substrate, or a plastic flexible substrate, and a plurality of electrodes 122 are disposed on the lower substrate 121.

Referring to FIG. 7F, after preparing the lower substrate 121, the mold rotation driver 230 is driven, so that the soft mold 180 is transferred from the filling table 210 to the compression table 220. For instance, the mold rotation driver 230 rotates the soft mold 180 about 180°, to transfer the soft mold 180 from the filling table 210 to the compression table 220, thereby disposing the dielectric sheet 150 on the exposed electrodes 222, which are disposed on the lower substrate 121.

The soft mold 180 is vertically aligned with the electrodes 122 and the lower substrate 121. In order to perform the alignment process, alignment marks (not shown) may be formed on the soft mold 180 and on the lower substrate 121. The alignment marks may be recognized by the CCD 160, to determine an alignment state between the soft mold 180 and the lower substrate 121. Any misalignment can be corrected, based on image data produced by the CCD 160. A misalignment may be corrected by moving the lower substrate 121, since it is easier to move the lower substrate 121 than the soft mold 180. For example, the electrodes 122 can be aligned between barrier ribs (or adjacent portions of the barrier rib material P), in order to perform exact addressing operations. The above-described alignment process is carried out during the manufacture of the lower panel.

Referring to FIG. 7G, the dielectric sheet 150 is compressed and bonded (compression bonded) to the lower substrate 121, by applying pressure to a reverse surface of the soft mold 180, using a pressure unit 270. Thus, the underlying dielectric sheet 150 is compressed and bonded to the lower substrate 121, so that the electrodes 122 are buried by the dielectric sheet 150. The pressure unit 270 may be, for example, a pressure roller that is rotated from one end of the soft mold 180 to another end thereof, to apply a predetermined pressure to the soft mold 180. The dielectric sheet 150 is a conventional dielectric layer that electrically insulates the electrodes 122 from each other, and protects the electrodes 122 from a discharge environment. The dielectric sheet 150 can have a thickness that is sufficient to provide a close adhesion of the dielectric sheet 150 to the electrodes 122, and apply a sufficient pressure to the dielectric sheet 150.

When the dielectric sheet 110 is bonded to the lower substrate 120, the barrier rib material P may be cured, as illustrated in FIG. 7H. The curing process may be performed when using a curable barrier rib material P, which has variable developing properties, according to temperature conditions and light exposure amounts. For example, when a photosensitive paste is used as the barrier rib material P; UV light L is radiated to the barrier rib material P contained in the soft mold 180, so that the barrier rib material P is cured, and integrally combined with the dielectric sheet 150. The cured barrier rib material P constitutes the barrier ribs 302, which have shapes corresponding to the channels 181 of the soft mold 180. The barrier ribs 302 are structurally connected to one another, by the dielectric sheet 150. The barrier ribs 302, the dielectric sheet 150, and the lower substrate 121, to form a lower panel 300.

Referring to FIG. 7I, the soft mold 180 is released from the lower panel 300, by driving the mold rotation driver 230. The released soft mold 180 is transferred onto the filling table 210, by the mold rotation driver 230, and the lower panel 300remains on the compression table 220. The electrodes 122 of the lower substrate 121 are covered by the dielectric sheet 150. The barrier ribs 302 partition discharge spaces.

According to some embodiments, the lower panel 300 may be sintered at an appropriate temperature, for example, at a temperature of about 500° C., or higher As a result, the barrier ribs 701 can be stably shaped, and an adhesion of the dielectric sheet 180 to the lower substrate 121, can be reinforced.

A process cycle, including a series of the operations that have been described above, with reference to FIGS. 7A through 7I, may be repetitively performed to produce the lower panel 300, in large quantities. The soft mold 180, which is repetitively reused within its own lifetime, may undergo a cleaning process, as illustrated in FIG. 7J, after a process cycle is completed, and before the next cycle begins. Barrier rib material residue attached to the soft mold 180, may affect the shape of barrier ribs that will be manufactured during the next cycle, and is therefore, removed during a cleaning process. That is, by driving the mold rotation driver 230, the soft mold 180 disposed on the filling table 210 is loaded into a cleaning tank CB, disposed below the mold rotation driver 230.

Referring to FIG. 7J, the filling table 210 may be moved away from the mold rotation driver 230, so as not to obstruct the movement of the soft mold 180. The cleaning tank CB includes a cleaning solution 240 containing a solvent, to dissolve the barrier rib material residue. The cleaning tank CB may further include an ultrasonic oscillator, to ultrasonically oscillate the cleaning solution 240. Thus, the residue attached to the soft mold 180 may be rapidly removed, due to frictional oscillations between the soft mold 180 and the cleaning solution 240. A cleaning roller 245, which simultaneously rotates and moves up and down, and which includes a brush attached to an outer surface thereof, may be installed in the cleaning tank CB. The cleaning roller 245 can facilitate the removal of the residue from the soft mold 180. The cleaned soft mold 180 is transferred onto the filling table 210, by the mold rotation driver 230, for the next manufacturing cycle.

Although it is exemplarily described that the barrier ribs and the lower panel are manufactured using the soft mold, the present invention is not limited thereto, and a hard mold, for example, may be used instead of the soft mold. In the method of manufacturing the lower panel, according to aspects of the present invention, a barrier rib pattern is formed using a molding process, so that barrier ribs having a desired shape can be precisely formed, without shape limitations. In particular, since the dielectric sheet with a uniform thickness is used as a dielectric layer to bury electrodes, the thickness of the dielectric layer can be controlled easily and uniformly.

Aspects of the present invention provide an apparatus to manufacture the lower panel. The technical principles of the present invention can be embodied in an automated or semi-automated system, thereby greatly enhancing process simplicity, productivity, and accelerating the shift to mass production of PDPs, using automated equipment.

Although a few exemplary embodiments of the present invention have been shown and described, it would be appreciated by those skilled in the art that changes may be made in these exemplary embodiments, without departing from the principles and spirit of the invention, the scope of which is defined in the claims and their equivalents.

What is claimed is:

1. A method of manufacturing barrier ribs of a plasma display panel, the method comprising:
preparing a mold having channels to shape the barrier ribs, disposed on a first surface thereof;
filling the channels with a barrier rib material, to form the barrier ribs; and
compressing a dielectric sheet against the mold, to bond the dielectric sheet to the barrier ribs.

2. The method of claim 1, wherein the mold is a flexible soft mold.

3. The method of claim 1, wherein the filling of the channels with the barrier rib material comprises using a squeegee to remove excess barrier rib material from the mold.

4. The method of claim 1, wherein the barrier rib material comprises a photosensitive paste.

5. The method of claim 1, further comprising curing the barrier ribs in the mold, after the dielectric sheet is bonded to the barrier ribs.

6. The method of claim 1, further comprising:
releasing the mold from the barrier ribs and the dielectric sheet; and
sintering the dielectric sheet and the barrier ribs.

7. A method of manufacturing a lower panel for a plasma display panel, the method comprising:
preparing a mold having channels to shape barrier ribs, disposed on a first surface of the mold;
filling the channels with a barrier rib material, to form the barrier ribs;
compressing a dielectric sheet against the mold, to bond the dielectric sheet to the barrier ribs; and
compressing the dielectric sheet against a substrate that comprises exposed electrodes, to bond the dielectric sheet to the substrate, and thereby form the lower panel.

8. The method of claim 7, wherein the compressing of the dielectric sheet against the substrate comprises aligning the mold with the electrodes.

9. The method of claim 7, wherein, the compressing of the dielectric sheet against the substrate comprises burying the electrodes with the dielectric sheet.

10. The method of claim 7, further comprising curing the barrier ribs in the mold, after the dielectric sheet is bonded to the substrate.

11. The method of claim 7, further comprising:
releasing the mold from the lower panel; and
sintering the lower panel.

12. A method of manufacturing a lower panel of a plasma display panel, using a manufacturing apparatus that comprises a filling table disposed on a first side of the manufacturing apparatus, a compression table disposed on a second side of the manufacturing apparatus, and a mold rotation driver to transfer a mold to shape barrier ribs between the filling table and the compression table, the method comprising:
disposing the mold on the filling table, and attaching the mold on the mold rotation driver;
filling channels of the mold with a barrier rib material, to form barrier ribs, while the mold is stabilized by the filling table;
compressing a dielectric sheet against the mold, to bond the dielectric sheet to the barrier ribs;
disposing a substrate having a plurality of exposed electrodes on the compression table;
driving the mold rotation driver to transfer the dielectric sheet onto the substrate; and
compressing the dielectric sheet against the substrate to bond the dielectric sheet to the substrate, and thereby form the lower panel, by compressing the mold against the compression table.

13. The method of claim 12, wherein, the compressing of the dielectric sheet against the substrate comprises burying the electrodes with the dielectric sheet.

14. The method of claim 12, further comprising curing the barrier ribs in the mold, after the dielectric sheet is bonded to the substrate.

15. The method of claim 12, further comprising:
driving the mold rotation driver to release the mold from the lower panel; and
loading the mold into a cleaning tank disposed between the compression table and the filling table, to clean the mold.

16. The method of claim 15, wherein the loading of the mold into the cleaning tank comprises moving the filling table away from the mold rotation driver.

17. The method of claim 12, wherein the driving the mold rotation driver to transfer the dielectric sheet comprises inverting the mold above the compression table.

18. The method of claim 7, wherein the compressing of the dielectric sheet against the substrate comprises applying pressure to a second surface of the mold, which opposes the first surface.

19. The method of claim 7, wherein the dielectric sheet has a substantially uniform thickness after being bonded to the substrate.

20. The method of claim 5, wherein the mold is transparent.
